(19) United States
(12) Patent Application Publication
(10) Pub. No.: US 2026/0148517 A1
(43) Pub. Date: May 28, 2026

(54) METHOD, APPARATUS, AND READABLE STORAGE MEDIUM FOR INFRARED IMAGE SMALL TARGET RECOGNITION

(71) Applicant: SUZHOU UNIVERSITY OF SCIENCE AND TECHNOLOGY, SUZHOU (CN)

(72) Inventors: JUNWU BAI, SUZHOU (CN); YIQIONG LI, SUZHOU (CN)

(73) Assignee: SUZHOU UNIVERSITY OF SCIENCE AND TECHNOLOGY, SUZHOU (CN)

(21) Appl. No.: 19/398,114

(22) Filed: Nov. 24, 2025

(30) Foreign Application Priority Data
Nov. 26, 2024 (CN) 202411697878.5

(51) Int. Cl. G06V 10/26; G06V 10/10; G06V 10/24; G06V 10/28; G06V 10/44; G06V 10/75; G06V 10/762; G06V 20/17

(52) U.S. Cl. CPC G06V 10/267; G06V 10/16; G06V 10/24; G06V 10/28; G06V 10/44; G06V 10/751; G06V 10/762; G06V 20/17; G06V 2201/07

(57) ABSTRACT

The present invention relates to a method comprises: performing geographical registration on an infrared image and an optical image of an area to be detected to obtain a target infrared image and a target optical image; clustering pixels in the target optical image to obtain a plurality of pixel clusters; extracting boundary pixels of the pixel clusters and performing a raster-to-vector operation on the boundary pixels to obtain segmentation boundary coordinates, thereby segmenting the target infrared image; fitting feature values of pixels in each infrared sub-image after segmentation to obtain a GEV model; optimizing the GEV model and obtaining a background model for the infrared sub-image based on the optimized GEV model; and performing target recognition on the infrared sub-image using the background model of the infrared sub-image, and obtaining a small target recognition result for the infrared image based on target recognition results of all infrared sub-images.

### TECHNICAL FIELD

The present invention relates to the technical field of target recognition, and more particularly, to a method, an apparatus, and a computer-readable storage medium for small target recognition in infrared images.

### BACKGROUND

With the development of Unmanned Aerial Vehicle (UAV) remote sensing technology, UAVs equipped with infrared sensors are playing an important role in fields such as environmental monitoring and ground object recognition. Due to their unique imaging characteristics, small targets in UAV infrared images often lack definitive shape and texture information. In complex and variable ground environments, small targets can be submerged in background noise, making recognition difficult. Therefore, how to accurately recognize small targets in UAV infrared images is an urgent problem to be solved.

Traditional methods for small target recognition in infrared images are mainly divided into two categories. The first category is based on image filtering, which enhances the original infrared image through filtering to increase the difference between small targets and the background, making the small targets more prominent. Subsequently, feature extraction and target detection are performed on the processed infrared image to recognize the small target regions. The second category is based on pattern recognition, which treats small target recognition as a classification problem, achieving small target detection and recognition by determining whether each pixel in the filtered and enhanced infrared image belongs to a target class or a background class. These two methods typically rely on image enhancement and filtering, performing small target recognition based on the assumption that the contrast between the small target and the background can be clearly distinguished through filtering enhancement or feature extraction. However, small targets in infrared images often have low contrast, and the background may contain complex noise, textures, or dynamic changes. Therefore, when the background has strong interference or the similarity between the small target and the background is high, processing methods that solely rely on image filtering and pixel classification find it difficult to accurately recognize small targets.

In response to the aforementioned problems, a target recognition method based on background statistical information has also been proposed in the prior art. This method involves selecting pixel samples in the infrared image to estimate a Gaussian distribution, calculating the mean vector and covariance matrix of these pixel samples, and then constructing a multivariate Gaussian distribution function. This multivariate Gaussian distribution function is used as a background model to describe the probability distribution of background pixels in the infrared image. Subsequently, an empirical probability threshold is set, and the feature value of each pixel in the infrared image is substituted into the background model. The model outputs a probability value that the pixel belongs to the background. If the output probability value is less than the probability threshold, the pixel is determined to be a small target, thus achieving small target recognition in the infrared image. By grasping the statistical characteristics of the background as a whole and deeply understanding the distribution of background pixels in the feature space, rather than simply filtering and enhancing the image or performing isolated classification of pixels, this method achieves higher recognition accuracy compared to traditional small target recognition methods. However, with the increase in the resolution of UAV infrared images, the backgrounds in which small targets are located become more complex, and the amount of detail information in the background increases significantly. Background pixels no longer conform to a single probability distribution. Using a simple probability distribution model cannot accurately describe the distribution characteristics of background pixels, and the resulting background model has low precision, thereby affecting the accuracy of small target recognition.

In summary, existing methods for small target recognition in UAV infrared images suffer from the problem that the constructed background model cannot accurately describe the distribution characteristics of background pixels in the infrared image, which in turn leads to low accuracy of the small target recognition results obtained based on this background model.

### SUMMARY

Accordingly, the technical problem to be solved by the present invention is to overcome the problem in the prior art where the background model constructed by existing methods for small target recognition in UAV infrared images cannot accurately describe the distribution characteristics of background pixels in the infrared image, leading to low accuracy of the small target recognition results obtained based on this background model.

To solve the above technical problem, the present invention provides a method for small target recognition in an infrared image, comprising:
obtaining an infrared image of an area to be detected and an optical image of the area to be detected, and performing geographical registration on the infrared image and the optical image to obtain a target infrared image and a target optical image;
clustering pixels in the target optical image to obtain a plurality of pixel clusters; extracting boundary pixels of each pixel cluster using an edge detection algorithm, and performing a raster-to-vector operation on the boundary pixels of each pixel cluster to obtain segmentation boundary coordinates corresponding to each pixel cluster;
segmenting the target infrared image based on the segmentation boundary coordinates corresponding to all pixel clusters to obtain a plurality of infrared sub-images;
fitting feature values of all pixels in each infrared sub-image using a Generalized Extreme Value (GEV) distribution method to obtain a GEV model for the infrared sub-image, and constructing a parameter likelihood function of the GEV model based on a maximum likelihood estimation (MLE) method; optimizing the GEV model based on the parameter likelihood function, and obtaining a background model for the infrared sub-image based on the optimized GEV model; and
performing target recognition on each pixel in the infrared sub-image using the background model of each infrared sub-image, and obtaining a small target recognition result for the infrared image based on target recognition results of all infrared sub-images.

Preferably, the GEV model for an i^{th} infrared sub-image is represented as:

$${H}_{i} ( x , μ , σ , ξ ) = exp \{ - {( 1 + ξ \frac{x - μ}{σ} )}^{- \frac{1}{ξ}} \} , 1 + ξ \frac{( x - μ )}{σ} > 0$$

wherein, Hᵢ(x, μ, σ, ξ) represents the GEV model for the i^{th} infrared sub-image; x represents a feature value of a pixel; μ represents a location parameter of the GEV model; σ represents a scale parameter of the GEV model; and ξ represents a shape parameter of the GEV model;
the parameter likelihood function of the GEV model is represented as:

$${ln [ L ( θ \vert x ) ]}_{i} = - {n}_{i} ln ( σ ) + {\sum }_{j = 1}^{{n}_{i}} [ ( \frac{1}{ξ} - 1 ) ln ( {y}_{j} ) - {( {y}_{j} )}^{\frac{1}{ξ}} ]$$

wherein, ln[L(θ|x)]ᵢ represents the parameter likelihood function of the GEV model Hᵢ(x, μ, σ, ξ); θ=(μ, σ, ξ); and nᵢ represents a number of pixels, in the i^{th} infrared sub-image;

$${y}_{j} = [ 1 - ( \frac{ξ}{σ} ) ( x - μ ) ] .$$

Preferably, optimizing the GEV model based on the parameter likelihood function comprises:
calculating a first partial derivative of the parameter likelihood function with respect to the location parameter of the GEV model, and setting the first partial derivative to 0 to obtain a location parameter equation;
calculating a second partial derivative of the parameter likelihood function with respect to the scale parameter of the GEV model, and setting the second partial derivative to 0 to obtain a scale parameter equation;
calculating a third partial derivative of the parameter likelihood function with respect to the shape parameter of the GEV model, and setting the third partial derivative to 0 to obtain a shape parameter equation; and
constructing a system of parameter equations based on the location parameter equation, the scale parameter equation, and the shape parameter equation, and solving the system of parameter equations using a Newton-Raphson method to obtain a target location parameter value, a target scale parameter value, and a target shape parameter value, thereby optimizing the GEV model.

Preferably, after obtaining the background model for each infrared sub-image, the method further comprises:
calculating a Kullback-Leibler (KL) divergence between a probability density function (PDF) of the background model of each infrared sub-image and a probability distribution function corresponding to a background histogram of the infrared sub-image, and using the KL divergence as a fitting accuracy of the background model for the infrared sub-image;
respectively determining whether the fitting accuracy of the background model of each infrared sub-image is greater than a preset threshold;
in response to determining that the fitting accuracy of the background model of an i^{th} infrared sub-image is greater than the preset threshold, obtaining, in the target optical image, pixels at spatial locations identical to pixels in the i^{th} infrared sub-image to obtain a set of pixels; and
clustering the set of pixels to obtain a plurality of target pixel clusters, thereby segmenting the i^{th} infrared sub-image based on the plurality of target pixel clusters to obtain a plurality of new infrared sub-images.

Preferably, a formula for calculating the KL divergence between the PDF of the background model of the infrared sub-image and the probability distribution function corresponding to the background histogram of the infrared sub-image is:

$${KL}_{i} = [ {p}_{i} ( x ) \vert {q}_{i} ( x ) ] = \int {p}_{i} ( x ) log \frac{{p}_{i} ( x )}{{q}_{i} ( x )} dx$$

wherein, KLᵢ represents the KL divergence; pᵢ(x) represents the PDF of the background model of the i^{th} infrared sub-image; and qᵢ(x) represents the probability distribution function corresponding to the background histogram of the i^{th} infrared sub-image.

Preferably, performing target recognition on each pixel in the infrared sub-image using the background model of each infrared sub-image, and obtaining the small target recognition result for the infrared image based on the target recognition results of all infrared sub-images comprises: calculating a detection threshold for the infrared sub-image using a bisection method based on a probability density function (PDF) of the background model of each infrared sub-image and a preset false alarm probability; respectively determining whether a feature value of each pixel in the infrared sub-image is greater than the detection threshold, and determining pixels whose feature value is greater than the detection threshold as small target pixels in the infrared sub-image; and obtaining small target pixels of the infrared image based on the small target pixels in all infrared sub-images.

Preferably, a formula for calculating the detection threshold for the infrared sub-image is:

$${p}_{fa} = {\int }_{{T}_{i}}^{∞} {p}_{i} ( x ) dx$$

wherein, p_{fa} represents the preset false alarm probability; pᵢ(x) represents the PDF of the background model of the i^{th} infrared sub-image; and Tᵢ represents the detection threshold for the i^{th} infrared sub-image.

Preferably, obtaining the infrared image of the area to be detected comprises: acquiring a plurality of images of the area to be detected using an Unmanned Aerial Vehicle (UAV), and performing geometric correction on each image based on pose information of the UAV; and stitching the corrected plurality of images to obtain the infrared image of the area to be detected.

The present invention also provides an apparatus for small target recognition in an infrared image, comprising:
an image acquisition and registration module, configured to obtain an infrared image of an area to be detected and an optical image of the area to be detected, and perform geographical registration on the infrared image and the optical image to obtain a target infrared image and a target optical image;
a segmentation boundary coordinate acquisition module, configured to cluster pixels in the target optical image to obtain a plurality of pixel clusters; extract boundary pixels of each pixel cluster using an edge detection algorithm, and perform a raster-to-vector operation on the boundary pixels of each pixel cluster to obtain segmentation boundary coordinates corresponding to each pixel cluster;
an infrared image segmentation module, configured to segment the target infrared image based on the segmentation boundary coordinates corresponding to all pixel clusters to obtain a plurality of infrared sub-images;
a background model construction module, configured to fit feature values of all pixels in each infrared sub-image using a Generalized Extreme Value (GEV) distribution method to obtain a GEV model for the infrared sub-image, and construct a parameter likelihood function of the GEV model based on a maximum likelihood estimation (MLE) method; optimize the GEV model based on the parameter likelihood function, and obtain a background model for the infrared sub-image based on the optimized GEV model; and
a small target recognition module, configured to perform target recognition on each pixel in the infrared sub-image using the background model of each infrared sub-image, and obtain a small target recognition result for the infrared image based on target recognition results of all infrared sub-images.

In a preferred embodiment, the small target recognition result is not merely stored but is actively used to control the UAV or assist the operator. Specifically, upon detecting a small target pixel exceeding the dynamic threshold, the small target recognition module 50 generates a physical control signal transmitted to the UAV's flight controller (not shown). This signal may trigger an autonomous modification of a flight parameter, such as reducing flight speed to reduce motion blur, locking the gimbal camera onto the target's coordinates, or switching the UAV to a ‘loiter’ mode around the detected target area.

In the context of the present invention, a ‘small target’ typically refers to an object occupying a small number of pixels in the image (e.g., less than 15×15 pixels or occupying less than 0.15% of the total image area), which often lacks sufficient internal texture features for traditional shape-based recognition.

The present invention also provides a computer-readable storage medium, wherein the computer-readable storage medium stores a computer program, and the computer program, when executed by a processor, implements the steps of the method for small target recognition in an infrared image described above.

The processor may be an embedded computing platform optimized for edge processing, such as a Field-Programmable Gate Array (FPGA), a Digital Signal Processor (DSP), or a GPU-accelerated embedded system (e.g., NVIDIA Jetson series), which allows for the parallel execution of the pixel clustering and GEV modeling steps in real-time during flight.

The method for small target recognition in an infrared image provided by the present application simultaneously obtains the optical image and the infrared image of the area to be detected. By matching the two images in geographical space, a target infrared image and a target optical image with the same coordinate system and spatial reference are obtained. Because the feature values of pixels of the same type of object are relatively similar, segmenting the target infrared image based on similar pixels can yield infrared sub-images of different background types, achieving a division of background types. However, because infrared images mainly reflect the thermal radiation information of objects, they cannot clearly describe the shape and texture details of buildings or other objects in the background. In contrast, optical images can not only display the shapes of various objects in the background but also contain color information. Therefore, the present application clusters the pixels in the target optical image to obtain a plurality of pixel clusters, extracts the boundary pixels of each pixel cluster, and performs a raster-to-vector operation on the boundary pixels of each pixel cluster to obtain the segmentation boundary coordinates corresponding to each pixel cluster, thereby segmenting the target infrared image to obtain multiple infrared sub-images of different background types. Because the distribution characteristics of background pixels in infrared sub-images of different background types are different, their corresponding background model parameters are also different. Therefore, the present application performs targeted background modeling for each infrared sub-image and uses the background model of each infrared sub-image to perform small target recognition on that sub-image. This avoids the problem of low small target recognition accuracy that occurs when a background model constructed for the entire infrared image in a complex background cannot fully fit the pixel distribution characteristics of various background types. Furthermore, because the increase in infrared image resolution causes the distribution characteristics of background pixels to deviate from a Gaussian distribution, the present application uses the Generalized Extreme Value (GEV) distribution method to construct the background model for each infrared sub-image. This not only better fits the asymmetric distribution and extreme value situations of background pixels in high-resolution infrared sub-images but also more accurately captures the shape and features of the background pixel distribution, enabling the constructed background model to accurately reflect the background pixel distribution characteristics of the infrared sub-images, thereby improving the accuracy of small target recognition.

### BRIEF DESCRIPTION OF DRAWINGS

To make the content of the present invention easier to understand clearly, the present invention will be further described in detail below based on specific embodiments of the present invention and in conjunction with the accompanying drawings, wherein:

FIG. 1 is a flowchart of a method for small target recognition in an infrared image provided by the present application.

FIG. 2 is a structural schematic diagram of an apparatus for small target recognition in an infrared image provided by the present application.

### DETAILED DESCRIPTION

The present invention is further described below with reference to the accompanying drawings and specific embodiments, so that persons skilled in the art can better understand and implement the present invention, but the listed embodiments are not intended to limit the present invention.

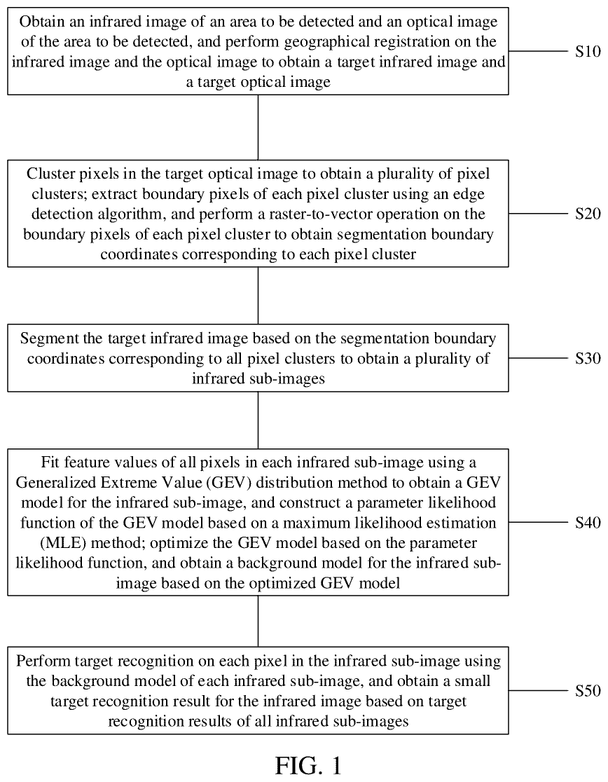

Please refer to FIG. 1. FIG. 1 shows a flowchart of a method for small target recognition in an infrared image provided by the present application. The method comprises:

S10: Obtain an infrared image of an area to be detected and an optical image of the area to be detected, and perform geographical registration on the infrared image and the optical image to obtain a target infrared image and a target optical image.

In some embodiments, obtaining the infrared image of the area to be detected comprises:
acquiring a plurality of images of the area to be detected using an Unmanned Aerial Vehicle (UAV), and performing geometric correction on each image based on pose information of the UAV;
stitching the corrected plurality of images to obtain the infrared image of the area to be detected.

Further, the geographical location of each object in the target optical image is the same as the geographical location of that object in the target infrared image; that is, the geographical locations of the respective pixels in the target optical image correspond one-to-one with the geographical locations of the respective pixels in the target infrared image.

S20: Cluster pixels in the target optical image to obtain a plurality of pixel clusters; extract boundary pixels of each pixel cluster using an edge detection algorithm, and perform a raster-to-vector operation on the boundary pixels of each pixel cluster to obtain segmentation boundary coordinates corresponding to each pixel cluster.

Specifically, in one embodiment, when clustering the pixels in the target optical image, the number of building categories in the target optical image can be roughly determined based on the function or structure of the buildings. This number of categories is used as the number of cluster centers. A pixel is randomly selected from the area covered by each type of building, and the feature value of that pixel is used as the cluster center for that category.

Further, the feature value of a pixel can be an RGB value, a gray value, or an HSV value.

S30: Segment the target infrared image based on the segmentation boundary coordinates corresponding to all pixel clusters to obtain a plurality of infrared sub-images.

S40: Fit feature values of all pixels in each infrared sub-image using a Generalized Extreme Value (GEV) distribution method to obtain a GEV model for the infrared sub-image, and construct a parameter likelihood function of the GEV model based on a maximum likelihood estimation (MLE) method; optimize the GEV model based on the parameter likelihood function, and obtain a background model for the infrared sub-image based on the optimized GEV model.

S50: Perform target recognition on each pixel in the infrared sub-image using the background model of each infrared sub-image, and obtain a small target recognition result for the infrared image based on target recognition results of all infrared sub-images.

The method for small target recognition in an infrared image provided by the present application simultaneously obtains the optical image and the infrared image of the area to be detected. By matching the two images in geographical space, a target infrared image and a target optical image with the same coordinate system and spatial reference are obtained. Because the feature values of pixels of the same type of object are relatively similar, segmenting the target infrared image based on similar pixels can yield infrared sub-images of different background types, achieving a division of background types. However, because infrared images mainly reflect the thermal radiation information of objects, they cannot clearly describe the shape and texture details of buildings or other objects in the background. In contrast, optical images can not only display the shapes of various objects in the background but also contain color information. Therefore, the present application clusters the pixels in the target optical image to obtain a plurality of pixel clusters, extracts the boundary pixels of each pixel cluster, and performs a raster-to-vector operation on the boundary pixels of each pixel cluster to obtain the segmentation boundary coordinates corresponding to each pixel cluster, thereby segmenting the target infrared image to obtain multiple infrared sub-images of different background types. Because the distribution characteristics of background pixels in infrared sub-images of different background types are different, their corresponding background model parameters are also different. Therefore, the present application performs targeted background modeling for each infrared sub-image and uses the background model of each infrared sub-image to perform small target recognition on that sub-image. This avoids the problem of low small target recognition accuracy that occurs when a background model constructed for the entire infrared image in a complex background cannot fully fit the pixel distribution characteristics of various background types.

Specifically, after the resolution of the infrared image is increased, the detail features of ground objects in the image are more prominent, and the image background is more complex. According to the Central Limit Theorem, the increase in resolution will cause the statistical distribution of the image's background pixels to deviate from a Gaussian distribution. Based on this, the present application uses a non-Gaussian GEV distribution for background modeling. Because the GEV distribution has higher degrees of freedom, it can well fit the background pixel distribution in the infrared image, and the constructed background model can also more accurately reflect the distribution characteristics of the background pixels in the infrared sub-images.

Specifically, in some embodiments of the present application, the GEV model for an i^{th} infrared sub-image is represented as:

$${H}_{i} ( x , μ , σ , ξ ) = exp ( - {( 1 + ξ \frac{x - μ}{σ} )}^{- \frac{1}{ξ}} \} , 1 + ξ \frac{( x - μ )}{σ} > 0$$

wherein, Hᵢ(x, μ, σ, ξ) represents the GEV model for the i^{th} infrared sub-image; x represents a feature value of a pixel; μ represents a location parameter of the GEV model; σ represents a scale parameter of the GEV model; and ξ represents a shape parameter of the GEV model;
the parameter likelihood function of the GEV model is represented as:

$${ln [ L ( θ \vert x ) ]}_{i} = - {n}_{i} ln ( σ ) + {\sum }_{j = 1}^{{n}_{i}} [ ( \frac{1}{ξ} - 1 ) ln ( {y}_{j} ) - {( {y}_{j} )}^{\frac{1}{ξ}} ]$$

wherein, ln[L(θ|x)]ᵢ represents the parameter likelihood function of the GEV model Hᵢ(x, μ, σ, ξ); θ=(μ, σ, ξ); and nᵢ represents a number of pixels, in the i^{th} infrared sub-image;

$${y}_{j} = [ 1 - ( \frac{ξ}{σ} ) ( x - μ ) ] .$$

Further, optimizing the GEV model based on the parameter likelihood function comprises:
calculating a first partial derivative of the parameter likelihood function with respect to the location parameter of the GEV model, and setting the first partial derivative to 0 to obtain a location parameter equation;
calculating a second partial derivative of the parameter likelihood function with respect to the scale parameter of the GEV model, and setting the second partial derivative to 0 to obtain a scale parameter equation;
calculating a third partial derivative of the parameter likelihood function with respect to the shape parameter of the GEV model, and setting the third partial derivative to 0 to obtain a shape parameter equation; and
constructing a system of parameter equations based on the location parameter equation, the scale parameter equation, and the shape parameter equation, and solving the system of parameter equations using a Newton-Raphson method to obtain a target location parameter value, a target scale parameter value, and a target shape parameter value, thereby optimizing the GEV model.

To determine the accuracy of the background model for each infrared sub-image, the present application uses KL divergence to measure the fitting accuracy between the background model and the background histogram of the infrared sub-image. Specifically, after obtaining the background model for each infrared sub-image, the method further comprises:
calculating a Kullback-Leibler (KL) divergence between a probability density function (PDF) of the background model of each infrared sub-image and a probability distribution function corresponding to a background histogram of the infrared sub-image, and using the KL divergence as a fitting accuracy of the background model for the infrared sub-image;
respectively determining whether the fitting accuracy of the background model of each infrared sub-image is greater than a preset threshold;
in response to determining that the fitting accuracy of the background model of an i^{th} infrared sub-image is greater than the preset threshold, obtaining, in the target optical image, pixels at spatial locations identical to pixels in the i^{th} infrared sub-image to obtain a set of pixels; and
clustering the set of pixels to obtain a plurality of target pixel clusters, thereby segmenting the i^{th} infrared sub-image based on the plurality of target pixel clusters to obtain a plurality of new infrared sub-images.

Specifically, a formula for calculating the KL divergence between the PDF of the background model of the infrared sub-image and the probability distribution function corresponding to the background histogram of the infrared sub-image is:

$${KL}_{i} = [ {p}_{i} ( x ) \vert {q}_{i} ( x ) ] = \int {p}_{i} ( x ) log \frac{{p}_{i} ( x )}{{q}_{i} ( x )} dx$$

wherein, KLᵢ represents the KL divergence; pᵢ(x) represents the PDF of the background model of the i^{th} infrared sub-image; and qᵢ(x) represents the probability distribution function corresponding to the background histogram of the i^{th} infrared sub-image.

In a specific example of the present application, the preset threshold for judging fitting accuracy is 0.2. If the fitting accuracy is greater than 0.2, it indicates that the constructed background model cannot accurately fit the background of the infrared sub-image. The infrared sub-image is further segmented, and new background models are rebuilt for the new infrared sub-images obtained from segmentation, until the fitting accuracy of the background models for all infrared sub-images reaches the preset value.

By verifying the goodness of fit between the background model and the background histogram of the infrared sub-image, the accuracy of the background model is improved, which in turn improves the accuracy of the recognition results when performing small target recognition based on this background model.

Optionally, in some embodiments of the present application, when performing small target recognition for each infrared sub-image in step S50, an empirical probability threshold can be set. Then, the pixels in the infrared sub-image are input into the corresponding background model, which outputs a probability value that the pixel belongs to the background. This probability value is compared with the probability threshold to determine whether the pixel belongs to the background or to a small target.

In other embodiments of the present application, the bisection method can also be used to solve for the detection threshold of each infrared sub-image. The specific recognition process comprises: calculating a detection threshold for the infrared sub-image using a bisection method based on a probability density function (PDF) of the background model of each infrared sub-image and a preset false alarm probability; respectively determining whether a feature value of each pixel in the infrared sub-image is greater than the detection threshold, and determining pixels whose feature value is greater than the detection threshold as small target pixels in the infrared sub-image; and obtaining small target pixels of the infrared image based on the small target pixels in all infrared sub-images.

Specifically, a formula for calculating the detection threshold for the infrared sub-image is:

$${p}_{fa} = {\int }_{{T}_{i}}^{∞} {p}_{i} ( x ) dx$$

wherein, p_{fa} represents the preset false alarm probability; pᵢ(x) represents the PDF of the background model of the i^{th} infrared sub-image; and Tᵢ represents the detection threshold for the i^{th} infrared sub-image.

Embodiments of the present application adopt a method based on mathematical principles and statistical laws to calculate the detection threshold for the infrared sub-image. The preset false alarm threshold considers the probability of errors allowed during the recognition process and can be set according to the requirements of the actual task. Simultaneously, combined with the bisection method, the optimal detection threshold is gradually approached by continuously dividing intervals. This avoids the problem of the detection threshold being too high or too low due to human factors when setting the detection threshold based on experience, which would otherwise lead to low accuracy in small target recognition.

In a specific embodiment, when performing small target recognition for each infrared sub-image, 1 or 0 can be used to mark whether each pixel belongs to a target or to the background. Finally, the regions where small targets are located in the infrared image are obtained based on the markings of all pixels in all infrared sub-images.

Based on the method for small target recognition in an infrared image provided by the above embodiments, an embodiment of the present application also provides an apparatus for small target recognition in an infrared image.

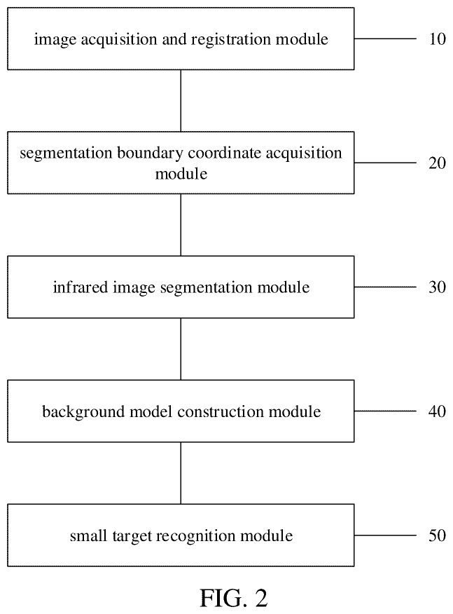

As shown in FIG. 2, the apparatus comprises:
an image acquisition and registration module 10, configured to obtain an infrared image of an area to be detected and an optical image of the area to be detected, and perform geographical registration on the infrared image and the optical image to obtain a target infrared image and a target optical image;
a segmentation boundary coordinate acquisition module 20, configured to cluster pixels in the target optical image to obtain a plurality of pixel clusters; extract boundary pixels of each pixel cluster using an edge detection algorithm, and perform a raster-to-vector operation on the boundary pixels of each pixel cluster to obtain segmentation boundary coordinates corresponding to each pixel cluster;
an infrared image segmentation module 30, configured to segment the target infrared image based on the segmentation boundary coordinates corresponding to all pixel clusters to obtain a plurality of infrared sub-images;
a background model construction module 40, configured to fit feature values of all pixels in each infrared sub-image using a Generalized Extreme Value (GEV) distribution method to obtain a GEV model for the infrared sub-image, and construct a parameter likelihood function of the GEV model based on a maximum likelihood estimation (MLE) method; optimize the GEV model based on the parameter likelihood function, and obtain a background model for the infrared sub-image based on the optimized GEV model; and
a small target recognition module 50, configured to perform target recognition on each pixel in the infrared sub-image using the background model of each infrared sub-image, and obtain a small target recognition result for the infrared image based on target recognition results of all infrared sub-images.

An embodiment of the present application also provides a computer-readable storage medium, on which a computer program is stored. The computer program, when executed by a processor, implements the steps of the method for small target recognition in an infrared image described above.

Persons skilled in the art should understand that the embodiments of the present application may be provided as a method, system, or computer program product. Therefore, the present application may take the form of an embodiment entirely of hardware, an embodiment entirely of software, or an embodiment combining software and hardware aspects. Furthermore, the present application may take the form of a computer program product implemented on one or more computer-usable storage media (including but not limited to disk storage, CD-ROM, optical storage, etc.) having computer-usable program code embodied therein.

The present application is described with reference to flowcharts and/or block diagrams of methods, apparatuses (systems), and computer program products according to embodiments of the present application. It should be understood that each flow and/or block in the flowcharts and/or block diagrams, and combinations of flows and/or blocks in the flowcharts and/or block diagrams, can be implemented by computer program instructions. These computer program instructions may be provided to a processor of a general-purpose computer, a special-purpose computer, an embedded processor, or other programmable data processing device to produce a machine, such that the instructions, which execute via the processor of the computer or other programmable data processing device, create means for implementing the functions specified in one or more flows of the flowchart and/or one or more blocks of the block diagram.

These computer program instructions may also be stored in a computer-readable memory that can direct a computer or other programmable data processing device to function in a particular manner, such that the instructions stored in the computer-readable memory produce an article of manufacture including instruction means which implement the functions specified in one or more flows of the flowchart and/or one or more blocks of the block diagram.

These computer program instructions may also be loaded onto a computer or other programmable data processing device to cause a series of operational steps to be performed on the computer or other programmable device to produce a computer-implemented process, such that the instructions which execute on the computer or other programmable device provide steps for implementing the functions specified in one or more flows of the flowchart and/or one or more blocks of the block diagram.

It is worth noting that the present invention provides a specific technical improvement to the functioning of image processing computers in the context of multispectral analysis. Traditional infrared processing relies solely on the pixel intensity of the infrared image itself, which consumes excessive computational resources when dealing with high-resolution non-Gaussian noise and often fails to distinguish background clutter from targets. By utilizing the heterogeneous segmentation approach—specifically using the texture-rich optical image to define the processing boundaries for the texture-poor infrared image—the system optimizes the computer's processing logic. This “optical-guided infrared segmentation” creates a specific data relationship between the two sensors that allows the processor to isolate statistical noise distributions more accurately than generic filtering. This is not merely a mathematical calculation but a specific technique for organizing image data in memory to overcome the physical limitations (lack of texture) of infrared sensors.

For example, this relationship may be instantiated in the memory as a mask matrix or a region-ID map, where each infrared pixel is tagged with a cluster ID derived from the optical image, strictly limiting the statistical noise modeling to physically consistent regions.

The infrared sensor may be a Long-Wave Infrared (LWIR) or Mid-Wave Infrared (MWIR) thermal camera, while the optical sensor may be a high-resolution visible light camera.

It is worth noting that the present invention provides a specific technical improvement to the functioning of image processing computers in the context of multispectral analysis. Traditional infrared processing relies solely on the pixel intensity of the infrared image itself, which consumes excessive computational resources when dealing with high-resolution non-Gaussian noise and often fails to distinguish background clutter from targets. By utilizing the heterogeneous segmentation approach—specifically using the texture-rich optical image to define the processing boundaries for the texture-poor infrared image—the system optimizes the computer's processing logic. This “optical-guided infrared segmentation” creates a specific data relationship between the two sensors that allows the processor to isolate statistical noise distributions more accurately than generic filtering. This is not merely a mathematical calculation but a specific technique for organizing image data in memory to overcome the physical limitations (lack of texture) of infrared sensors.

It should be understood that the mathematical models and equations described herein (including the GEV model functions Hi, likelihood functions lnL, and KL divergence calculations) are not performed mentally but are implemented as specific algorithmic instructions executed by the processor of the target recognition apparatus. For instance, the optimization of the GEV model involves the processor iteratively solving the system of parameter equations using the Newton-Raphson method stored in the memory. Similarly, the calculation of the detection threshold is performed by the processor dynamically executing a bisection algorithm against the constructed background model for each sub-region in real-time or near real-time, allowing the UAV system to adapt its detection sensitivity to the changing thermal noise characteristics of the terrain.

In a preferred embodiment, the small target recognition result is not merely stored but is actively used to control the UAV or assist the operator. Specifically, upon detecting a small target pixel exceeding the dynamic threshold, the small target recognition module 50 generates a physical control signal transmitted to the UAV's flight controller (not shown). This signal may trigger an autonomous modification of a flight parameter, such as reducing flight speed to reduce motion blur, locking the gimbal camera onto the target's coordinates, or switching the UAV to a ‘loiter’ mode around the detected target area

In a preferred embodiment, the small target recognition result is not merely stored but is actively used to control the UAV or assist the operator. Specifically, upon detecting a small target pixel exceeding the dynamic threshold, the small target recognition module 50 generates a physical control signal transmitted to the UAV's flight controller (not shown). This signal may trigger an autonomous modification of a flight parameter, such as reducing flight speed to reduce motion blur, locking the gimbal camera onto the target's coordinates, or switching the UAV to a ‘loiter’ mode around the detected target area.

Alternatively, or in conjunction with the flight parameter modification, the system transmits the recognition result to a remote control terminal. The terminal renders an augmented detection overlay on its display interface, where the detected small target is highlighted with a visual marker (e.g., a bounding box or a flashing cursor), thereby transforming the raw thermal data into a visual guidance cue for the operator.

Obviously, the foregoing embodiments are merely examples for clear illustration and are not intended to limit the implementation. For persons of ordinary skill in the art, other different forms of changes or modifications can be made on the basis of the above description. There is no need and no way to exhaust all embodiments. Any obvious changes or modifications derived therefrom still fall within the protection scope of the present invention.

What is claimed is:

1. A method for small target recognition in an infrared image, comprising:
obtaining an infrared image of an area to be detected and an optical image of the area to be detected, and performing geographical registration on the infrared image and the optical image to obtain a target infrared image and a target optical image;
clustering pixels in the target optical image to obtain a plurality of pixel clusters; extracting boundary pixels of each pixel cluster using an edge detection algorithm, and performing a raster-to-vector operation on the boundary pixels of each pixel cluster to obtain segmentation boundary coordinates corresponding to each pixel cluster;
segmenting the target infrared image based on the segmentation boundary coordinates corresponding to all pixel clusters to obtain a plurality of infrared sub-images;
fitting feature values of all pixels in each infrared sub-image using a Generalized Extreme Value (GEV) distribution method to obtain a GEV model for the infrared sub-image, and constructing a parameter likelihood function of the GEV model based on a maximum likelihood estimation (MLE) method; optimizing the GEV model based on the parameter likelihood function, and obtaining a background model for the infrared sub-image based on the optimized GEV model; and
performing target recognition on each pixel in the infrared sub-image using the background model of each infrared sub-image, and obtaining a small target recognition result for the infrared image based on target recognition results of all infrared sub-images.

2. The method of claim 1, wherein the GEV model for an i^{th} infrared sub-image is represented as:
$${H}_{i} ( x , μ , σ , ξ ) = exp \{ - {( 1 + ξ \frac{x - μ}{σ} )}^{- \frac{1}{ξ}} \} , 1 + ξ \frac{( x - μ )}{σ} > 0$$
wherein, Hᵢ(x, μ, σ, ξ) represents the GEV model for the i^{th} infrared sub-image; x represents a feature value of a pixel; μ represents a location parameter of the GEV model; σ represents a scale parameter of the GEV model; and ξ represents a shape parameter of the GEV model;
the parameter likelihood function of the GEV model is represented as:
$${ln [ L ( θ \vert x ) ]}_{i} = - {n}_{i} ln ( σ ) + {\sum }_{j = 1}^{{n}_{i}} [ ( \frac{1}{ξ} - 1 ) ln ( {y}_{j} ) - {( {y}_{j} )}^{\frac{1}{ξ}} ]$$
wherein, lnᵢ represents the parameter likelihood function of the GEV model Hᵢ(x, μ, σ, ξ); θ=(μ, σ, ξ); and nᵢ represents a number of pixels, in the i^{th} infrared sub-image;
$${y}_{j} = [ 1 - ( \frac{ξ}{σ} ) ( x - μ ) ] .$$

3. The method of claim 2, wherein optimizing the GEV model based on the parameter likelihood function comprises:
calculating a first partial derivative of the parameter likelihood function with respect to the location parameter of the GEV model, and setting the first partial derivative to 0 to obtain a location parameter equation;
calculating a second partial derivative of the parameter likelihood function with respect to the scale parameter of the GEV model, and setting the second partial derivative to 0 to obtain a scale parameter equation;
calculating a third partial derivative of the parameter likelihood function with respect to the shape parameter of the GEV model, and setting the third partial derivative to 0 to obtain a shape parameter equation; and
constructing a system of parameter equations based on the location parameter equation, the scale parameter equation, and the shape parameter equation, and solving the system of parameter equations using a Newton-Raphson method to obtain a target location parameter value, a target scale parameter value, and a target shape parameter value, thereby optimizing the GEV model.

4. The method of claim 1, wherein after obtaining the background model for each infrared sub-image, the method further comprises:
calculating a Kullback-Leibler (KL) divergence between a probability density function (PDF) of the background model of each infrared sub-image and a probability distribution function corresponding to a background histogram of the infrared sub-image, and using the KL divergence as a fitting accuracy of the background model for the infrared sub-image;
respectively determining whether the fitting accuracy of the background model of each infrared sub-image is greater than a preset threshold;
in response to determining that the fitting accuracy of the background model of an i-th infrared sub-image is greater than the preset threshold, obtaining, in the target optical image, pixels at spatial locations identical to pixels in the i-th infrared sub-image to obtain a set of pixels; and
clustering the set of pixels to obtain a plurality of target pixel clusters, thereby segmenting the i-th infrared sub-image based on the plurality of target pixel clusters to obtain a plurality of new infrared sub-images.

5. The method of claim 4, wherein a formula for calculating the KL divergence between the PDF of the background model of the infrared sub-image and the probability distribution function corresponding to the background histogram of the infrared sub-image is:
$${KL}_{i} = [ {p}_{i} ( x ) \vert {q}_{i} ( x ) ] = \int {p}_{i} ( x ) log \frac{{p}_{i} ( x )}{{q}_{i} ( x )} dx$$
wherein, KLᵢ represents the KL divergence; pᵢ(x) represents the PDF of the background model of the i^{th} infrared sub-image; and qᵢ(x) represents the probability distribution function corresponding to the background histogram of the i^{th} infrared sub-image.

6. The method of claim 1, wherein performing target recognition on each pixel in the infrared sub-image using the background model of each infrared sub-image, and obtaining the small target recognition result for the infrared image based on the target recognition results of all infrared sub-images comprises:
calculating a detection threshold for the infrared sub-image using a bisection method based on a probability density function (PDF) of the background model of each infrared sub-image and a preset false alarm probability;
respectively determining whether a feature value of each pixel in the infrared sub-image is greater than the detection threshold, and determining pixels whose feature value is greater than the detection threshold as small target pixels in the infrared sub-image; and
obtaining small target pixels of the infrared image based on the small target pixels in all infrared sub-images.

7. The method of claim 6, wherein a formula for calculating the detection threshold for the infrared sub-image is:
$${p}_{fa} = {\int }_{{T}_{i}}^{∞} {p}_{i} ( x ) dx$$
wherein, p_{fa} represents the preset false alarm probability; pᵢ(x) represents the PDF of the background model of the i^{th} infrared sub-image; and Tᵢ represents the detection threshold for the i^{th} infrared sub-image.

8. The method of claim 1, wherein obtaining the infrared image of the area to be detected comprises:
acquiring a plurality of images of the area to be detected using an Unmanned Aerial Vehicle (UAV), and performing geometric correction on each image based on pose information of the UAV; and
stitching the corrected plurality of images to obtain the infrared image of the area to be detected.

9. An apparatus for small target recognition in an infrared image, comprising:
an image acquisition and registration module, configured to obtain an infrared image of an area to be detected and an optical image of the area to be detected, and perform geographical registration on the infrared image and the optical image to obtain a target infrared image and a target optical image;
a segmentation boundary coordinate acquisition module, configured to cluster pixels in the target optical image to obtain a plurality of pixel clusters; extract boundary pixels of each pixel cluster using an edge detection algorithm, and perform a raster-to-vector operation on the boundary pixels of each pixel cluster to obtain segmentation boundary coordinates corresponding to each pixel cluster;
an infrared image segmentation module, configured to segment the target infrared image based on the segmentation boundary coordinates corresponding to all pixel clusters to obtain a plurality of infrared sub-images;
a background model construction module, configured to fit feature values of all pixels in each infrared sub-image using a Generalized Extreme Value (GEV) distribution method to obtain a GEV model for the infrared sub-image, and construct a parameter likelihood function of the GEV model based on a maximum likelihood estimation (MLE) method; optimize the GEV model based on the parameter likelihood function, and obtain a background model for the infrared sub-image based on the optimized GEV model; and
a small target recognition module, configured to perform target recognition on each pixel in the infrared sub-image using the background model of each infrared sub-image, and obtain a small target recognition result for the infrared image based on target recognition results of all infrared sub-images.

10. A non-transitory computer-readable storage medium storing instructions, wherein the instructions, when executed by a processor, cause the processor to perform the method according to claim 1.

11. A specific small target recognition system for an Unmanned Aerial Vehicle (UAV), comprising:
a multispectral imaging assembly mounted on the UAV, including an infrared sensor configured to acquire an infrared image and an optical sensor configured to acquire an optical image;
a memory storing computer-executable instructions; and
one or more processors coupled to the multispectral imaging assembly and the memory, wherein execution of the instructions causes the system to perform operations comprising:
performing geographical registration on the infrared image and the optical image to generate a registered image pair sharing a common spatial reference;
generating a heterogeneous segmentation mask by clustering pixels in the optical image to identify structural boundaries of objects and converting the structural boundaries into vector coordinates;
applying the heterogeneous segmentation mask to the infrared image to partition the infrared image into a plurality of infrared sub-regions based on the structural boundaries derived from the optical image, thereby isolating background noise characteristics specific to different object types;
constructing a specific background noise model for each infrared sub-region using a Generalized Extreme Value (GEV) distribution that accounts for non-Gaussian thermal distribution in high-resolution imagery;
detecting a small target pixel within a specific infrared sub-region by comparing pixel intensity against a dynamic threshold derived from the specific background noise model of that sub-region; and
generating a physical control signal based on the detected small target pixel to modify a flight parameter of the UAV or to render an augmented detection overlay on a remote control terminal, thereby transforming the detected small target into a navigational or visual guidance cue.

12. The system of claim 11, wherein the operation of generating the heterogeneous segmentation mask creates a specific data structure that correlates optical texture edges with thermal radiation regions, improving the computer's ability to distinguish small targets from complex backgrounds compared to processing the infrared image in isolation.

13. The system of claim 11, wherein the operations further comprise an iterative refinement loop: calculating a Kullback-Leibler (KL) divergence between the constructed background noise model and a histogram of the infrared sub-region; determining if the KL divergence exceeds a fitting threshold; and in response to the KL divergence exceeding the threshold, strictly re-segmenting the corresponding region in the optical image to generate finer-grained sub-regions, and re-calculating the background noise model, thereby dynamically adapting the system's processing resources to complex terrain areas.

14. The system of claim 11, wherein the specific background noise model for an i^{th} infrared sub-region is configured as a Generalized Extreme Value (GEV) model represented as:
$${H}_{i} ( x , μ , σ , ξ ) = exp \{ - {( 1 + ξ \frac{x - μ}{σ} )}^{- \frac{1}{ξ}} \} , 1 + ξ \frac{( x - μ )}{σ} > 0$$
wherein, Hᵢ(x, μ, σ, ξ) represents the GEV model for the i^{th} infrared sub-image; x represents a feature value of a pixel; μ represents a location parameter of the GEV model; σ represents a scale parameter of the GEV model; and ξ represents a shape parameter of the GEV model;
the parameter likelihood function of the GEV model is represented as:
$${ln [ L ( θ \vert x ) ]}_{i} = - {n}_{i} ln ( σ ) + {\sum }_{j = 1}^{{n}_{i}} [ ( \frac{1}{ξ} - 1 ) ln ( {y}_{j} ) - {( {y}_{j} )}^{\frac{1}{ξ}} ]$$
wherein, lnᵢ represents the parameter likelihood function of the GEV model Hᵢ(x, μ, σ, ξ); θ=(μ, σ, ξ); and nᵢ represents a number of pixels, in the i^{th} infrared sub-image;
$${y}_{j} = [ 1 - ( \frac{ξ}{σ} ) ( x - μ ) ] .$$

15. The system of claim 14, wherein the processor is further configured to optimize the GEV model by: calculating partial derivatives of the parameter likelihood function with respect to the location parameter, the scale parameter, and the shape parameter; setting each partial derivative to zero to form a system of parameter equations; and executing a Newton-Raphson iterative solver to compute a target location parameter value, a target scale parameter value, and a target shape parameter value.

16. The system of claim 13, wherein the processor calculates the KL divergence using the formula:
$${KL}_{i} = [ {p}_{i} ( x ) \vert {q}_{i} ( x ) ] = \int {p}_{i} ( x ) log \frac{{p}_{i} ( x )}{{q}_{i} ( x )} dx$$
wherein, KLᵢ represents the KL divergence; pᵢ(x) represents the PDF of the background model of the i^{th} infrared sub-image; and qᵢ(x) represents the probability distribution function corresponding to the background histogram of the i^{th} infrared sub-image.

17. The system of claim 11, wherein the operation of detecting the small target pixel comprises:
calculating the dynamic threshold Tᵢ for the specific infrared sub-region using a bisection method based on a Probability Density Function (PDF) of the specific background noise model and a preset false alarm probability p_{fa}; and
identifying pixels with feature values greater than the dynamic threshold as small target pixels.

18. The system of claim 17, wherein a formula for calculating the detection threshold for the infrared sub-image is:
$${p}_{fa} = {\int }_{{T}_{i}}^{∞} {p}_{i} ( x ) dx$$
wherein, p_{fa} represents the preset false alarm probability; pᵢ(x) represents the PDF of the background model of the i^{th} infrared sub-image; and Tᵢ represents the detection threshold for the i^{th} infrared sub-image.

19. The system of claim 11, wherein the multispectral imaging assembly is configured to capture a series of raw images during flight, and the operations further comprise: performing geometric correction on each raw image based on real-time pose information from the UAV; and stitching the corrected images to generate the infrared image and the optical image of the area to be detected prior to geographical registration.
